(19) United States
(12) Patent Application Publication
(10) Pub. No.: US 2014/0038579 A1
(43) Pub. Date: Feb. 6, 2014

(54) Controlling Communication Mode Setting

(71) Applicant: Renesas Mobile Corporation, Tokyo (JP)

(72) Inventors: Tero Heikki Matti HENTTONEN, Espoo (FI); Brian MARTIN, Farnham (GB); Samuli TURTINEN, Il (FI); Jari Jaakko ISOKANGAS, Tampere (FI)

(73) Assignee: Renesas Mobile Corporation, Tokyo (JP)

(21) Appl. No.: 13/960,021

(22) Filed: Aug. 6, 2013

(30) Foreign Application Priority Data
Aug. 6, 2012 (GB) 1213973.9

(51) Int. Cl. H04W 8/22

(52) U.S. Cl. CPC H04W 8/22
USPC 455/418

(57) ABSTRACT

Measures for controlling a communication mode setting, such as a power saving procedure in a UE. A UE sends a communication mode preference indication to a communication network control element under consideration of a default prohibit timer. When a response to the communication mode preference indication is received by the UE, it determines whether a change of the behavior for transmitting the power preference information, e.g. a change of a prohibit timer value, is to be executed.

### CROSS REFERENCE TO RELATED APPLICATION

This application claims benefit under 35 U.S.C. §119(a) and 37 CFR 1.55 to UK patent application no. GB1213973.9, filed on 6 Aug. 2012, the entire content of which is hereby incorporated by reference.

### TECHNICAL FIELD

The present disclosure relates to measures for controlling a communication mode setting, such as a power saving procedure, in a communication element such as a UE. In particular, but not exclusively, the present disclosure is directed to apparatuses, methods and computer program products by means of which a communication mode, which includes for example a power saving procedure in a communication element, can be controlled in an improved manner.

The following meanings for the abbreviations used in this specification apply:
BS: base station
CPU: central processing unit
DRX: discontinuous reception
eNB: evolved node B
HFN: hyperframe number
IE: information element

### LTE: Long Term Evolution

### LTE-A: LTE Advanced

MTC: machine type communication
RNC: radio network controller
RRC: radio resource control
SFN: subframe number
SIB: system information block
UE: user equipment

### BACKGROUND

In recent years, an increasing extension of communication networks, e.g. of wire based communication networks, such as the Integrated Services Digital Network (ISDN), DSL, or wireless communication networks, such as the cdma2000 (code division multiple access) system, cellular 3rd generation (3G) communication networks such as the Universal Mobile Telecommunications System (UMTS), enhanced communication networks based e.g. on LTE, cellular 2nd generation (2G) communication networks like the Global System for Mobile communications (GSM), the General Packet Radio System (GPRS), the Enhanced Data Rates for Global Evolutions (EDGE), or other wireless communication systems, such as the Wireless Local Area Network (WLAN), Bluetooth or Worldwide Interoperability for Microwave Access (WiMAX), took place all over the world. Various organizations, such as the 3rd Generation Partnership Project (3GPP), Telecoms & Internet converged Services & Protocols for Advanced Networks (TISPAN), the International Telecommunication Union (ITU), 3rd Generation Partnership Project 2 (3GPP2), Internet Engineering Task Force (IETF), the IEEE (Institute of Electrical and Electronics Engineers), the WiMAX Forum and the like are working on standards for telecommunication networks and access environments.

In modern communication networks, such as UMTS, LTE or LTE-A based networks, the power consumption of the UE represents a problem for the general performance of the wireless data transmission. Thus, an important goal is to find and perform suitable power saving mechanisms for reducing power consumption. Discontinuous reception (DRX) is one commonly known and implemented example of a method to conserve the power in the UEs. DRX allows the UE, for example, to power off a radio receiver portion for a predefined period (called the DRX cycle) instead of continuously listening to the radio channel. The UE and the network (i.e. a corresponding communication network control element such as an eNB) negotiate phases in which data transfer can occur and hence also phases where it does not occur, i.e. during which the UE turns its receiver portion off and enters a low power state.

It is currently under discussion how a UE can indicate to the network (e.g. the eNB) that it desires to enter into a low power consumption mode. For indicating such a power preference, a signaling from the UE to the network can be used that allows toggling between a “default” state (i.e. a normal power mode) and a “lower power consumption” state. For example, it is up to the network to decide whether and how to make use of the indication. However, excessive signaling of information from the UE to the network may be the result.

### SUMMARY

Embodiments of the disclosure provide an apparatus, method and computer program product by means of which an improved control mechanism is provided for controlling a communication mode setting, such as a power saving procedure in a communication element such as a UE. In particular, according to embodiments of the present disclosure, apparatuses, methods and computer program products are provided by means of which a communication mode setting, such as a power saving procedure in a communication element can be controlled in an improved manner.

This is achieved by the measures defined in the attached claims.

According to an embodiment of the proposed solution, there is provided, for example, an apparatus for use in controlling a communication mode setting, the apparatus comprising at least one processor and at least one memory including computer program code, the at least one memory and the computer program code being configured to, with the at least one processor, cause the apparatus at least to perform a communication mode preference indication receiving function arranged to receive a communication mode preference indication, and a processing function arranged to process the received communication mode preference indication, wherein the processing function is further arranged, as a result of the processing, to cause sending of an explicit response to the communication element transmitting the communication mode preference indication, the response comprising an indicator indicating a response to the communication mode preference indication, or to cause sending of an implicit response to the communication element transmitting the communication mode preference indication by using a signaling with an indication for changing the behavior for transmitting the communication mode preference indication.

Furthermore, according to an embodiment of the proposed solution, there is provided, for example, a method for use in controlling a communication mode setting, the method comprising receiving a communication mode preference indication, and processing the received communication mode preference indication, and, as a result of the processing, causing sending of an explicit response to the communication element transmitting the communication mode preference indication, the response comprising an indicator indicating a response to the communication mode preference indication, or causing sending of an implicit response to the communication element transmitting the communication mode preference indication by using a signaling with an indication for changing the behavior for transmitting the communication mode preference indication.

In addition, according to an embodiment of the proposed solution, there is provided, for example, an apparatus for use in controlling a communication mode setting, the apparatus comprising at least one processor and at least one memory including computer program code, the at least one memory and the computer program code being configured to, with the at least one processor, cause the apparatus at least to perform a communication mode preference determination function arranged to determine that a specific communication mode preference exists in a communication element, a communication mode preference indication function arranged to cause transmission of the communication mode preference indication on the basis of a default prohibit timer defining a time period where a transmission of the communication mode preference indication is allowed or prohibited, a communication mode preference indication response detection function arranged to detect whether a response to the communication mode preference indication is received, and a processing function arranged to conduct a processing on the basis of the detection result for a response by the communication mode preference indication response detection function, wherein the processing function is further arranged in the case of a response to the communication mode preference indication being detected by the communication mode preference indication response detection function, to process the response for determining whether a behavior for transmitting the communication mode preference indication is to be changed, wherein in the case of the processing resulting in the behavior for transmitting the communication mode preference indication being changed, the processing function is further arranged to set a new prohibit timer value for modifying the default prohibit timer value.

Furthermore, according to an embodiment of the proposed solution, there is provided, for example, a method for use in controlling a communication mode setting, the method comprising determining that a specific communication mode preference exists in a communication element, causing transmission of the communication mode preference indication on the basis of a default prohibit timer defining a time period where a transmission of the communication mode preference indication is allowed or prohibited, detecting whether a response to the communication mode preference indication is received, and conducting a processing on the basis of the detection result for a response, wherein the processing includes in the case of a response to the communication mode preference indication being detected, processing the response for determining whether a behavior for transmitting the communication mode preference indication is to be changed, wherein in the case of the processing resulting in the behavior for transmitting the communication mode preference indication being changed, setting a new prohibit timer value for modifying the default prohibit timer value.

In addition, according to examples of the proposed solution, there is provided, for example, a computer program product for a computer, comprising software code portions for performing the steps of the above defined methods, when said product is run on the computer. The computer program product may comprise a computer-readable medium on which said software code portions are stored. Furthermore, the computer program product may be directly loadable into the internal memory of the computer and/or transmittable via a network by means of at least one of upload, download and push procedures.

Embodiments may include a computer program product comprising a non-transitory computer-readable storage medium having computer readable instructions stored thereon, the computer readable instructions being executable by a computerized device to cause the computerized device to perform a method for use in controlling a communication mode setting as described herein.

By virtue of the proposed solutions, it is possible to provide a mechanism for controlling a communication mode setting, for example a power saving procedure in a communication element such as a UE. The communication mode to be set may be, for example, a communication mode where lower power consumption by using e.g. a DRX mechanism or a fast dormancy mechanism is used, or a communication mode where a higher performance is desired. In the communication mode setting, the network, i.e. a communication network control element such as an RNC or eNB is able to control how frequently a UE is allowed to send communication mode preference indications so that the signaling load is controllable and reducible. Furthermore, a tighter control over the conditions in which the communication mode preference indication is sent is possible, for example by controlling the times in which such indications are allowed to be sent, which UEs are allowed to send such indications, etc. Moreover, it is possible that the UE sends the communication mode preference indication when necessary, whilst the eNB knows when this will happen, which increases the reliability of the communication process. Furthermore, the knowledge of the UE regarding the fact that the eNB has responded to the UE's request for a communication mode setting, such as for a communication mode with “low power consumption” can be improved. On the other hand, only a small increase in the signaling from eNB to UE when providing configuration data, such as DRX configuration data (e.g. due to an optional IE indicating whether the DRX was in response to a power preference indication) is required.

The above and still further features of embodiments will become more apparent upon referring to the description and the accompanying drawings.

### BRIEF DESCRIPTION OF THE DRAWINGS

FIG. 1 shows a signaling diagram illustrating a signaling exchange in a communication mode control procedure between a communication network control element and a communication element in a communication network according to embodiments.

FIG. 2 shows a flowchart illustrating an example of a control procedure conducted by a communication network control element according to embodiments.

FIG. 3 shows a flowchart illustrating an example of a control procedure conducted by a communication element according to embodiments.

FIG. 4 shows a block circuit diagram of a communication network control element including processing portions conducting functions according to embodiments.

FIG. 5 shows a block circuit diagram of a communication element including processing portions conducting functions according to embodiments.

### DETAILED DESCRIPTION

In the following, examples and embodiments of the present disclosure are described with reference to the drawings. For illustrating the present disclosure, the examples and embodiments will be described in connection with a cellular communication network based on a 3GPP LTE or LTE-A system. However, it is to be noted that the present disclosure is not limited to an application using such a communication system, but is also applicable in other types of communication systems and the like, for example in an UMTS based communication system.

A basic system architecture of a communication network where embodiments are applicable may include a commonly known architecture of one or more communication systems comprising a wired or wireless access network subsystem and a core network. Such an architecture may include one or more access network control elements, radio access network elements, access service network gateways or base transceiver stations, such as a base station (BS) or eNB, which control a coverage area also referred to as a cell and with which a communication element or terminal device such as a UE or another device having a similar function, such as a modem chipset, a chip, a module etc., which can also be part of a UE or attached as a separate element to a UE, or the like, is capable of communicating via one or more channels for transmitting several types of data. Furthermore, core network elements such as gateway network elements, policy and charging control network elements, mobility management entities and the like may be included.

The general functions and interconnections of the described elements, which also depend on the actual network type, are known to those skilled in the art and described in corresponding specifications, so that a detailed description thereof is omitted herein. However, it is to be noted that several additional network elements and signaling links may be employed for a communication to or from a communication element like a UE or a communication network control element like an RNC or an eNB etc., besides those described in detail herein below.

Furthermore, the described network elements, for example communication elements such as UEs, communication network control elements such as RNCs or eNBs, and the like, as well as corresponding functions as described herein may be implemented by software, e.g. by a computer program product for a computer, and/or by hardware. In any case, for executing their respective functions and/or algorithms, correspondingly used devices, nodes or network elements may include several means and components (not shown) which are required for control, processing and communication/signaling functionality. Such means may include, for example, one or more processing systems or processor units including one or more processing portions for executing instructions, programs and for processing data, memory means for storing instructions, programs and data, for serving as a work area of the processor or processing portion and the like (e.g. ROM, RAM, EEPROM, and the like), input means for inputting data and instructions by software (e.g. floppy disc, CD-ROM, EEPROM, and the like), user interface means for providing monitor and manipulation possibilities to a user (e.g. a screen, a keyboard and the like), interface means for establishing links and/or connections under the control of the processor unit or portion (e.g. wired and wireless interface means, an antenna, etc.) and the like. It is to be noted that in the present specification processing portions should not be only considered to represent physical portions of one or more processors, but may also be considered as a logical division of the referred processing tasks performed by one or more processors.

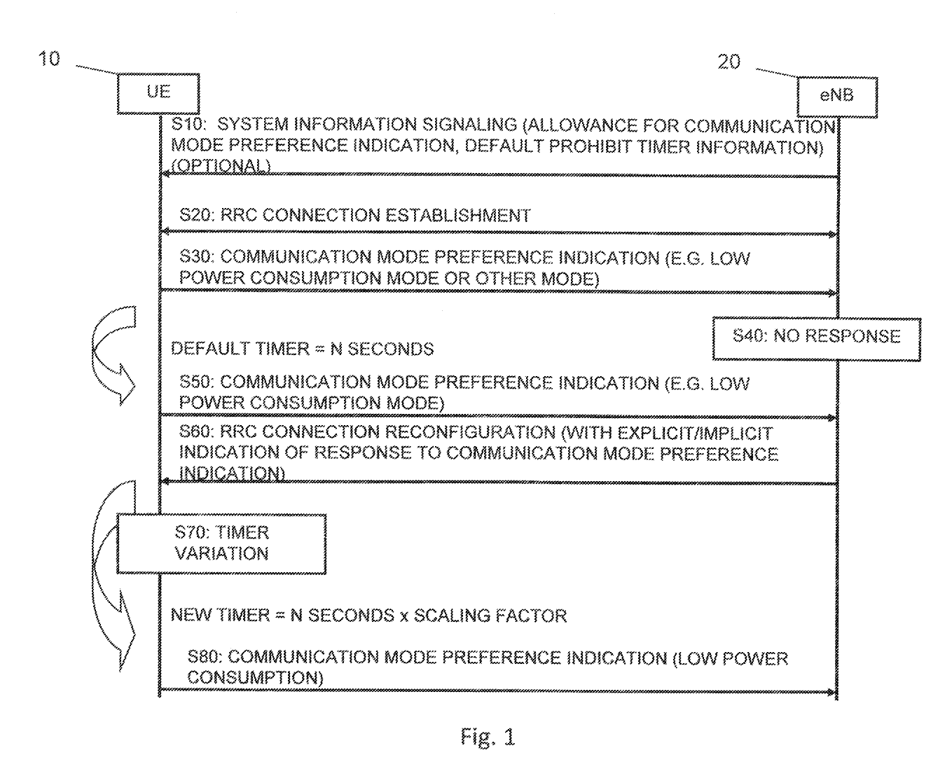

With regard to FIG. 1, embodiments will be described for a control mechanism related to a communication mode setting, wherein as one example a power saving procedure in a communication element such as a UE is described. However, it is to be noted that the control mechanism described in the following is also applicable for other communication mode settings, such as a communication mode for increased performance (where e.g. a DRX cycle is to be shortened), or another form of power saving procedure including, for example, a fast dormancy procedure as defined in connection with UMTS networks. That is, a communication mode preference indication as discussed according to embodiments may be one of an indication of a lower power consumption preference, an indication of an improved communication performance preference, or an indication for a fast dormancy request.

Specifically, FIG. 1 shows a signaling diagram illustrating a signaling exchange and processing steps conducted in a power control procedure which is executed in a communication network control element such as an eNB 20 and a communication element such as a UE 10 according to embodiments. It is to be noted that instead of the eNB 20, also an RNC (not shown) is usable as a communication network control element.

Embodiments are related to a procedure which allows control of the transmission of a communication mode preference indication in the form of e.g. a power preference information (i.e. indication that a low power mode is desired) from the UE 10 to the eNB 20 by controlling a prohibit timer operation. The prohibit timer is used to define a period of time between transmissions of communication mode preference indications from the UE wherein in this period a (re-) transmission of the communication mode preference indication is inhibited.

According to embodiments, the UE 10 is allowed to send the communication mode preference indication on the basis of a preset allowance inherent in the UE 10, i.e. the allowance is present by default (i.e. no external allowance indication is necessary). In this case, the UE 10 is prepared to send the communication mode preference indication, for example, as soon as a corresponding requirement is detected.

According to further embodiments, an allowance is provided by a communication network control element, such as the eNB 20, which allows the UE 10 to conduct a communication mode preference indication, if deemed to be required. In FIG. 1, a corresponding example with the provision of an allowance is shown (in the case of a preset allowance being provided in the UE, this step is omitted). Thus, as an initial step in the control mechanism according to embodiments, the eNB 20 indicates to UE(s) 10 whether it is allowed to send communication mode preference indications. According to one embodiment, as shown in FIG. 1 in step S10, this allowance information is provided via broadcast signaling, for example in form of a system information signaling. Alternatively, according to further embodiments, the allowance information can be provided to the respective UE via a dedicated signaling. According to still further embodiments, the allowance information is provided by both broadcast and dedicated signaling.

In broadcast signaling embodiments, the information regarding an allowance of the power preference indication is included, for example, in a system information message, i.e. within a specific SIB. According to one of embodiment, the allowance information is a one-bit indicator informing the UE that communication mode preference indications are allowed. Alternatively, according to a further embodiment, the allowance information is an indicator having a more complicated structure so that, for example, also a precise division to UE classes is possible; hence, it is for example possible to prescribe that only certain UEs are allowed to indicate the communication mode preference, such as only MTC capable UEs. According to yet another alternative embodiment, a group paging message is broadcast that indicates for receiving UEs that communication mode preference indication is now allowed for a certain period of time. This period of time is implicitly or explicitly configured in the self-same group paging message.

In dedicated signaling embodiments, on the other hand, the eNB 20 indicates to the UE 10 in a control signaling, such as an RRC configuration signaling, that a communication mode preference indication is allowed to be sent. For example, according to embodiments, the control signaling includes a bitmap or the like, such as a 2-bit bitmap that indicates whether the eNB 20 has the understanding that a UE communication mode preference indication has been received or not (1 bit), i.e. that the communication mode preference indication is receivable, and whether the eNB has acted upon the indication (1 bit), i.e. that the communication mode preference indication is also processable by the eNB 20. In another dedicated signaling embodiment, according to further embodiments, the allowance information is a one-bit IE that tells the UE that it is allowed to send the communication mode preference indication. In still another dedicated signaling embodiment, according to still further embodiments, the UE has informed the eNB 20 beforehand that the UE has the capability to communicate mode preference indication (i.e. tells the network that it supports the feature), and the eNB only provides allowance information to the UE in case it has received such a capability information beforehand).

In addition to the transmission of the allowance information, according to embodiments, the eNB 20 also provides the UE 10 with information regarding a default prohibit timer, for example in the same signaling as that used for the allowance information (i.e. the signaling in step S10 of FIG. 1), or in a separate signaling (not shown in FIG. 1).

It is to be noted that a UE may also have a preset timer usable as the default prohibit timer, e.g. in the form of a timer being hard-coded in a memory. In this case, according to embodiments, the default prohibit timer related information is for example an instruction to use this hard-coded timer. Furthermore, according to embodiments, no explicit information related to the default prohibit timer is required from the communication network control element, and the UE is prepared to start this timer on the basis of other information.

In the example shown in FIG. 1, it is assumed that information regarding the default prohibit timer is sent to the UE.

The default prohibit timer value is the basis of the prohibition mechanism for prohibiting the transmission of the communication mode preference indication from the UE 10 and is derivable, according to embodiments from an already existing parameter or a completely new parameter. For example, the prohibit timer value is indicated by means of an indication related to the start of an existing paging cycle (which is usually known for each UE). This is utilized for spreading the time instants for sending the communication mode preference indication for each UE. In other words, according to embodiments, the UE 10 is only allowed to send the communication mode preference indication once per paging cycle. According to further embodiments, an indication of e.g. the DRX SFN start-offset is used. The DRX SFN start-offset informs when the OnDuration of the UE begins in a DRX cycle. According to the present embodiments, this offset is used for informing about the prohibit timer value, so that the UE only sends the communication mode preference indication once per each hyperframe (HFN, i.e. once per 10.24 seconds, for example. According to still further embodiments, the information indicating the prohibit timer value is provided to the UE 10 by an information being keyed to a specific SFN, for example based on a new signaled parameter or a timer value signaled to the UE 10 that is (re)started every time the UE sends the communication mode preference indication. According to further embodiments, in case accuracy is less important, a simple indication based on seconds or milliseconds is provided to the UE 10 for indicating the prohibit timer value.

After a connection setup (see step 20 of FIG. 1 where an RRC connection establishment takes place), or similarly a handover or a connection re-establishment, the UE 10 having received the allowance in step S10 (or has the preset allowance) is prepared to send, in the case of the UE 10 determining that a condition is met where a specific communication mode is preferred, e.g. a low power consumption state, the communication mode preference indication at every fixed interval according to the default prohibit timer (for example, based on the UE-specific paging cycle start, or once every N seconds, etc.), to the communication network control element, i.e. the eNB 20 (see step S30). Once the UE 10 has sent the communication mode preference indication in step S30, the (default) prohibit timer is started during which the communication mode preference indication cannot be sent again. In the example shown in FIG. 1, the default prohibit timer is set to be N seconds.

On the eNB 20 side (e.g. after having allowed the communication mode preference indication in step S10), a receipt of a corresponding communication mode preference indication is awaited. According to embodiments, the receipt timing is known e.g. due to the prohibit timer value.

When receiving a communication mode preference indication, according to embodiments, the eNB 20 is configured to decide whether it answers the communication mode preference indication signaling or not. For example, in the case of the eNB 20 deciding that a low power state of the UE 10 is not suitable (e.g. due to a corresponding amount of data being present in a transmission buffer), the eNB 20 decides not to answer to the communication mode preference indication at all (as indicated in step S40).

In this case, as shown in step S50 in FIG. 1, after the prohibit timer is expired (i.e. after N seconds), the UE 10, in case the condition for the communication mode like the low power consumption mode is still present, sends a further (updated) communication mode preference indication to the eNB 20.

According to embodiments, the eNB 20 decides now that it will answer the communication mode preference indication signaling. That is, the eNB 20 decides for example that a low power state of the UE 10 is suitable, and the eNB 20 sends a response to the communication mode preference indication. According to embodiments, the eNB 20 sends an explicit response to the communication mode preference indication comprising, for example, an indicator identifying the message as a (direct) response to the communication mode preference indication. According to further embodiments, the eNB 20 sends an implicit response to the communication mode preference indication from which the UE 10 derives that it represents a response to the communication mode preference indication. The explicit and implicit responding will be described in the following.

For example, according to embodiments, the eNB 20 sends in step S60 an RRC connection reconfiguration message with which it configures a DRX cycle for the UE 10. According to embodiments, the eNB 20 indicates that the DRX configuration is for the communication mode setting (e.g. the UE power saving) corresponding to the communication mode preference indication. Alternatively, according to further embodiments, the UE 10 implicitly determines that the new configuration is a response to the sent communication mode preference indication, for example on the basis of a determination that a configured DRX length is increased (for power saving) or decreased (for better performance), or for example on the basis of a determination that a configured DRX OnDuration timer value is decreased or increased (i.e. the cycle length is not changed but the time in which the UE stays awake in a cycle is changed). According to further embodiments, the eNB 20 provides a configuration which meets a particular criterion (e.g. indication of a DRX cycle being equal to or longer than a predetermined time, or being equal to or shorter than a predetermined time, such as X [ms]). Furthermore, according to further embodiments, the eNB 20 provides an explicit indication, such as a flag indicating that the configuration is a response to a UE request for communication mode changing, such as for a power saving configuration.

When the UE 10 receives in step S60 the RRC connection reconfiguration message with the DRX configuration data comprising the explicit/implicit response, the UE 10 decides in step S70 whether and how the prohibit timer is to be varied. That is, according to embodiments, the UE 10 decides whether the (preceding) default prohibit timer value is to be maintained, or if the prohibit timer value is to be changed, according to the information included in the reconfiguration message.

For example, according to embodiments, the communication mode preference indication prohibit timer value received in step S10 or the preset value is scaled by an implicit or explicit amount. For example, the scaling is carried out implicitly by multiplying the timer value N by a scaling factor which may be a preset value or a value provided by the communication network control element. Otherwise, according to further embodiments, the scaling is carried out explicitly, e.g. by setting the timer value to a new timer value indicated by the eNB 20 in the signaling.

That is, as indicated in step S70, in the case of the eNB 20 providing e.g. a longer DRX cycle configuration, or a configuration which meets a particular criterion (e.g. DRX cycle being equal to or longer than X ms), or the eNB 20 provides an explicit indication (e.g. flag indicating that the configuration is a response to the UE request for e.g. power saving configuration or another communication mode setting), the UE 10 sets a new timer value and is thus restricted from sending another power preference indication for the new timer value being scaled by a scaling factor (e.g. N seconds*scaling factor, such as e.g. 4 times former DRX cycle length, or 2 times original timer value, etc.).

After the new timer value, in step S80, a further communication mode preference indication can be sent by the UE 10, if required.

According to further embodiments, in the case of the data received with the RRC connection reconfiguration signaling comprising, for example, information indicating a DRX cycle length which is not longer than the currently used DRX cycle length, or in the case of the UE not receiving DRX configuration data from the eNB 20, or the eNB 20 does not change the DRX configuration after a communication mode preference indication transmission, the scaling of the prohibit timer value is not applied since the eNB 20 has, for example, not provided a better power consumption condition via e.g. a longer DRX length. In other words, the UE 10 sends the communication mode preference indication normally taking into account the default prohibit timer value (i.e. no timer scaling is effected even after a possible eNB response).

That is, according to embodiments, the UE behavior regarding the transmission of the communication mode preference indication can be changed by the eNB 20 by means of data included in the response to a communication mode preference indication. That is, the UE can be prohibited from sending an (updated) indication once it receives a response from the eNB 20 for a specific time, which is determined by a new timer value.

In the preceding examples, a case is described where a communication is conducted in an LTE or LTE-A based network. Here, as one example of the communication mode preference indication, a power preference indication is sent and processed, for example. In the following, further embodiments are described where the communication is conducted, for example, in an UMTS based network where the communication network control element is e.g. an RNC. In this case, for example, the communication mode preference indication is e.g. a request for fast dormancy.

According to these embodiments, for example, the number of fast dormancy requests is limited, which are sent for example by setting IE “Signalling Connection Release Indication Cause” to “UE Requested PS Data session end” in SIGNALLING CONNECTION RELEASE INDICATION messages from UE, that are sent e.g. when the UE is in CELL_PCH (cell paging channel) or URA PCH (UTRAN registration area paging channel) state and the configured DRX length is not as short as an idle mode DRX. In case a network does not reconfigure the UE to idle state. Instead, after putting the UE in a CELL_PCH state, the NW keeps the UE there even when the UE sends further requests (e.g. to obtain a more power efficient configuration—idle mode).

In order to limit the load caused by sending corresponding communication mode preference indications for requesting, for example fast dormancy, according to embodiments, the RNC uses the response mechanism described above for configuring the UE communication mode preference indication transmission such that it is not completely stopped (which may be the case when limiting, for example, the total number of allowed indications). For this purpose, according to embodiments, the UE is caused to modify (i.e. increase) the prohibit timer so that the UE sends less frequently when the UE has been moved to CELL PCH/URA PCH state as a result of a fast dormancy request.

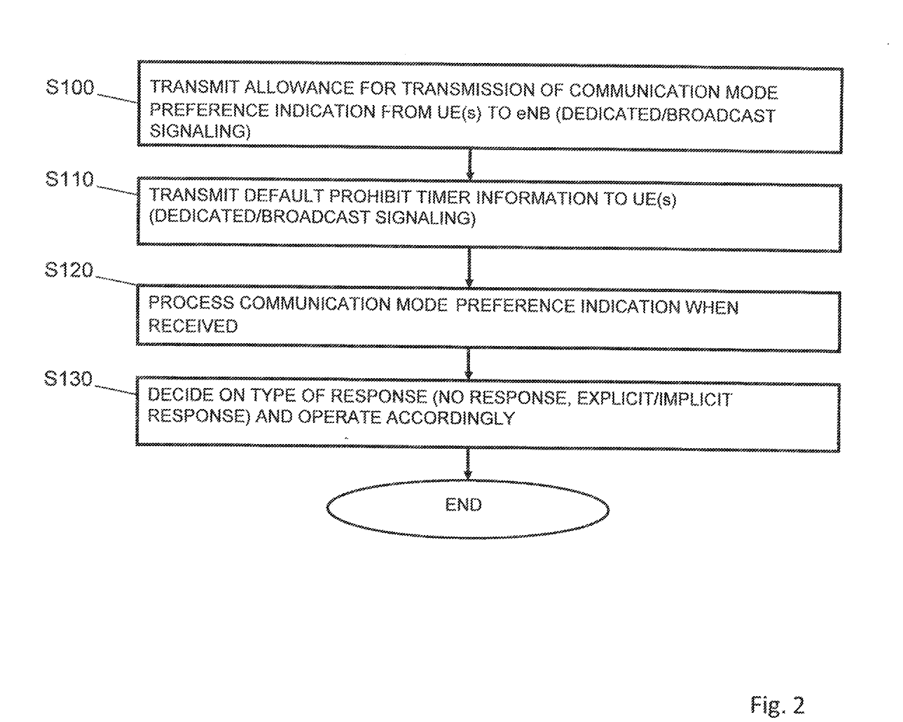

FIG. 2 shows a flowchart illustrating an example of a control procedure conducted by a communication network control element according to embodiments. That is, FIG. 2 shows a flowchart illustrating a processing for conducting a control procedure in a communication network control element such as the eNB 20 as shown in FIG. 1 according to embodiments.

In step S100, a transmission of an indication for allowing a transmission of a communication mode preference indication by a UE for requesting a specific communication mode of the communication element (e.g. the low power consumption mode) is caused in the eNB. As indicated above, the provision of an allowance is not always necessary, according to embodiments, so that step S100 could be also omitted.

As described, in the case of the allowance being provided, the transmission of the indication for allowing the transmission of the communication mode preference indication can be carried out by at least one of a dedicated signaling to at least one UE and a broadcast signaling.

In the case of a dedicated signaling to the at least one UE being used, according to embodiments, the indication for allowing the transmission of the communication mode preference indication is included in an RRC signaling to the at least one UE, wherein the indication includes, for example, at least one of a bitmap indicating whether the communication mode preference indication is receivable and processable, an information element indicating the allowance of transmission of the communication mode preference indication, and a response to an indication received from the at least one UE that a function for sending a communication mode preference indication is supported.

Otherwise, in the case of a broadcast signaling being used, according to embodiments, the indication for allowing the transmission of the communication mode preference indication is included in a system information signaling comprising at least one of a SIB including an indicator that communication mode preference indication is allowed, a SIB including an indicator that communication mode preference indication is allowed and an information element dividing UEs into classes of communication elements being allowed to send the communication mode preference indication and classes of UEs not being allowed to send the communication mode preference indication, and a group paging signaling indicating a specified time period for which the transmission of the communication mode preference indication is allowed.

In step S110, the eNB 20 provides information concerning a default prohibit timer defining a time period where a transmission of the communication mode preference indication is prohibited for the UE. As indicated above, the provision of information regarding the default prohibit timer is not always necessary, according to embodiments, so that step S110 could also be omitted.

Similarly to the allowance indication, the transmission of the information concerning the default prohibit timer value is transmitted, according to embodiments, by at least one of a dedicated signaling to the at least one UE and a broadcast signaling.

The information concerning the default prohibit timer is provided, according to embodiments, as a trigger element for triggering an internal timer as the default prohibit timer, a parameter including at least one of an explicit time period indication, an indication to use a paging cycle for spreading time instants for transmitting the communication mode preference indication, an indication of a start offset indicating to transmit the communication mode preference indication once per hyperframe, and an indication keyed to a subframe number.

In step S120, a communication mode preference indication is processed, if received from a UE (e.g. when being allowed to send a communication mode preference indication). For example, it is checked whether the communication mode preference setting is possible from the network point of view.

In step S130, a decision is made by the eNB 20, based on the processing result, as to how the communication mode preference indication is to be dealt with. That is, it is decided, according to embodiments, whether a transmission of a response to the communication mode preference indication is prohibited (i.e. no response is to be sent), or if one of an explicit response or implicit response to the UE transmitting the communication mode preference indication is sent, e.g. by using a RRC configuration signaling.

The explicit response includes, for example, an indicator indicating a response to the communication mode preference indication. The implicit response is related, for example, to a specific DRX configuration parameter. For example, in the case of an implicit response to the UE, a DRX configuration parameter indicating a specific DRC cycle is used, e.g. in the form of a DRX cycle being longer (shorter) than a previous DRX cycle, or in the form of a DRX cycle being equal to or longer (or shorter) than a predetermined value, depending on the requested communication mode type. That is, an indication is provided that the behavior for transmitting the communication mode preference indication is to be changed or modified.

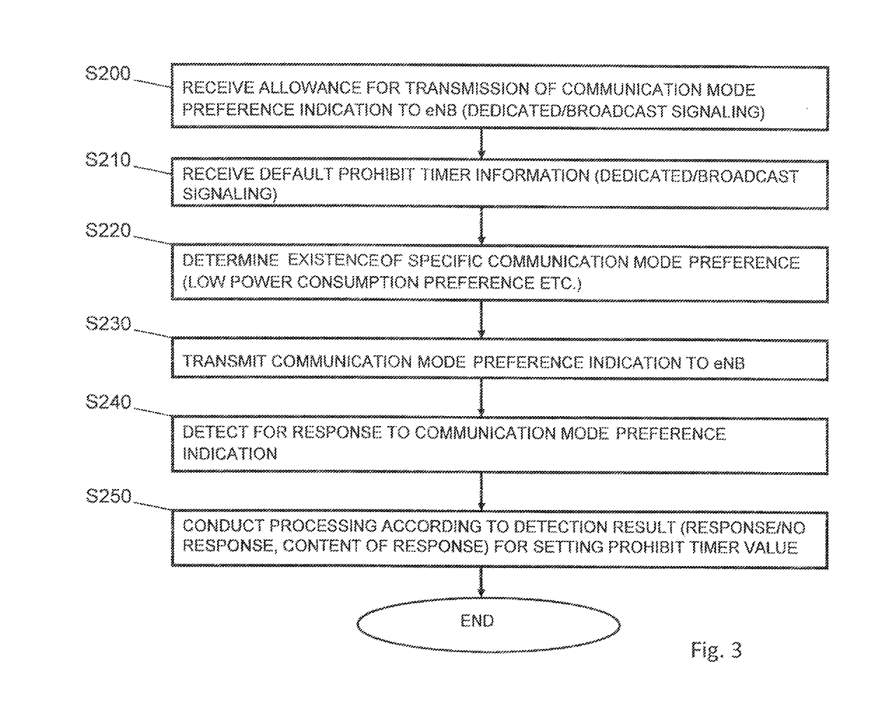

FIG. 3 shows a flowchart illustrating an example of a control procedure conducted by a communication element according to embodiments. That is, FIG. 3 shows a flowchart illustrating a processing for conducting a control procedure in a communication element such as the UE 10 as shown in FIG. 1 according to embodiments.

In step S200, the UE 10 receives an allowance to transmit a communication mode preference indication for requesting one of at least two different power modes of a communication element, such as a power preference indication for a low power consumption mode. As indicated above, the allowance may also be preset in the UE 10 (i.e. indication is always allowed) so that, according to embodiments, step S200 could be omitted.

As described above, in the case of an allowance being required, according to embodiments, the allowance for the communication mode preference indication transmission can be received via at least one of a dedicated signaling to the UE and a broadcast signaling.

In the case of a dedicated signaling to the UE being received, according to embodiments, the UE 10 determines the indication for the allowance for the transmission of the communication mode preference indication from a received RRC signaling, the indication comprising at least one of a bitmap indicating whether the communication mode preference indication is receivable and processable, an information element indicating the allowance of transmission of the communication mode preference indication, and a response to an indication sent by the UE 10 (not shown) that a function for sending a communication mode preference indication is supported.

In the case of a broadcast signaling being received, according to embodiments, the UE 10 determines the allowance for the transmission of the communication mode preference indication from a system information signaling comprising at least one of a SIB including an indicator that communication mode preference indication is allowed, a SIB including an indicator that communication mode preference indication is allowed and an information element indicating that the UE 10 is assigned to a class of UEs allowed to send the communication mode preference indication (in the case of the UE 10 learning that it belongs to a class of UEs not allowed to send the communication mode preference indication, the processing ends), and a group paging signaling indicating a specified time period in which the transmission of the communication mode preference indication is allowed.

In step S210, the UE 10 receives information concerning a default prohibit timer defining a time period where a transmission of the power preference indication is prohibited. As indicated above, the provision of an information regarding the default prohibit timer is not always necessary, according to embodiments, so that step S210 could be omitted.

As described, according to embodiments, the information concerning the default prohibit timer value can be received by at least one of a dedicated signaling to the UE and a broadcast signaling (e.g. in combination with the allowance indication, or by separate signaling).

According to embodiments, the UE 10 receives as the information concerning the default prohibit timer one of a trigger element for triggering an internal timer as the default prohibit timer, a parameter including at least one of an explicit time period indication, an indication to use a paging cycle for spreading time instants for transmitting the communication mode preference indication, an indication of a start offset indicating to transmit the communication mode preference indication once per hyperframe, and an indication keyed to a subframe number.

In step S220, the UE determines whether a specific communication mode preference exists in the UE, i.e. whether, for example, a low power consumption mode in order to save battery energy, for example, or a fast dormancy mode or a mode with increased performance is preferred.

In the case of the specific communication mode preference being determined in step S220, in step S230, a transmission of a corresponding communication mode preference indication is caused, wherein the information concerning the default prohibit timer is considered (that is, the communication mode preference indication is sent only when the prohibit timer allows the transmission, i.e. does not prohibit it).

In step S240, the UE 10 detects whether a response to the communication mode preference indication sent in step S230 is received. A reception of a response to the communication mode preference indication is determined, for example, when an explicit response is detected which uses for example an RRC configuration signaling comprising an indicator indicating a response to the communication mode preference indication. Alternatively, a reception of a response to the communication mode preference indication is determined, for example, when an implicit response is detected which uses an RRC configuration signaling with a DRX configuration parameter.

According to embodiments, an implicit response is received e.g. when a DRX configuration parameter indicating a specific DRX cycle is determined from the response, wherein the specific DRX cycle includes one of a DRX cycle longer (or shorter) than a previous discontinuous reception cycle, and a DRX cycle equal to or longer (or shorter) than a predetermined value, depending on the requested communication mode type.

In step S250, processing is conducted on the basis of a result of the detection for response to the communication mode preference indication. According to embodiments, in the processing, in case no response to the communication mode preference indication is detected, a (new) transmission of the communication mode preference indication is caused, again on the basis of the default prohibit timer (and when the specific communication mode preference still exists). Otherwise, in the case of a response to the communication mode preference indication being detected, the contents of the response (e.g. the DRX configuration date) are processed for determining whether a behavior for transmitting the communication mode preference indication is to be changed. According to embodiments, in the case of the processing resulting in the behavior for transmitting the communication mode preference indication being changed, a new prohibit timer value is set replacing the default prohibit timer value (e.g. the preset value or the value received in step S210). For example, the new prohibit timer value is calculated by multiplying the (previous) default prohibit timer value by a specified scaling factor. Otherwise, in the case of the processing resulting in the behavior for transmitting the communication mode preference indication being changed, the default prohibit timer value of step S210 is maintained and used for the transmission of a next power preference indication.

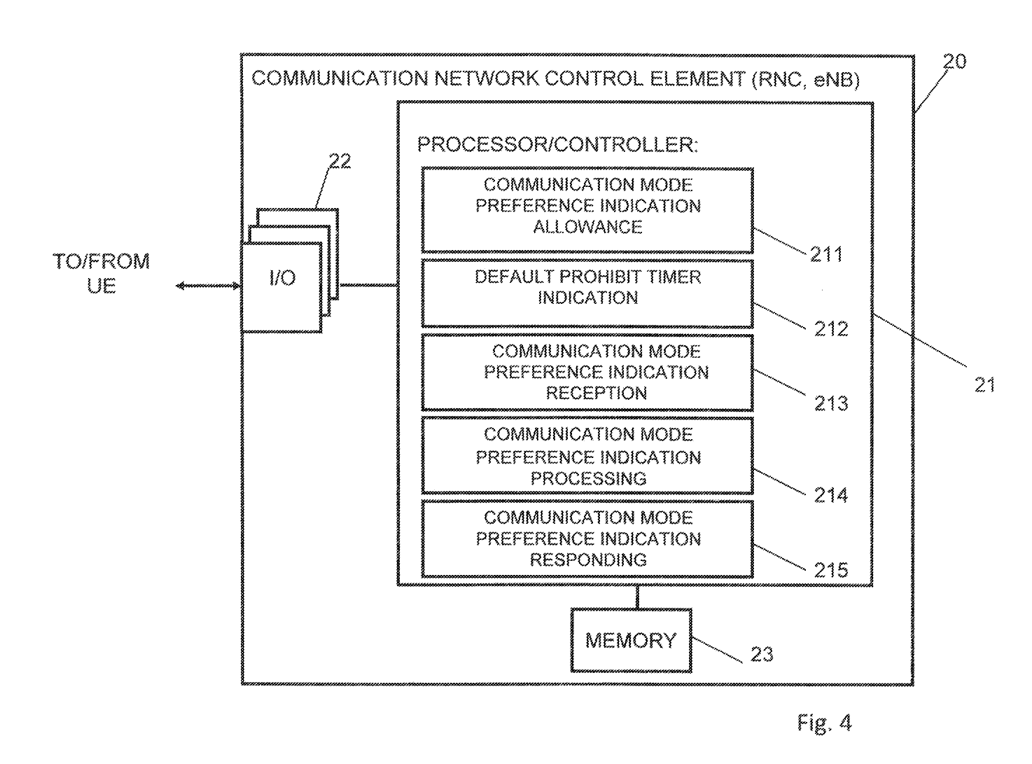

In FIG. 4, a block circuit diagram illustrating a circuitry indicating a configuration of a communication network control element, such as the RNC or eNB 20, is shown which is configured to implement the processing for the control mechanism of the communication mode setting as described in connection with the embodiments. That is, a circuitry is shown which includes a processing system and/or at least one processor and at least one memory including computer program code the at least one memory and the computer program code being configured to, with the at least one processor, cause the eNB 20 to perform functions described herein, for example by executing a corresponding algorithm. It is to be noted that the communication network control element or eNB 20 shown in FIG. 4 may include several further elements or functions besides those described herein, which are omitted for the sake of simplicity as they are not essential for understanding of embodiments. Furthermore, even though reference is made to an eNB, the communication network control element may also include another device having a similar function, such as an RNC, or a modem chipset, a chip, a module etc., which can also be part of a BS or eNB or attached as a separate element to a BS or eNB, or the like.

The communication network control element or eNB 20 may include a processing system or processing function or processor 21, such as a CPU or the like, which executes instructions given by programs or the like related to the control mechanism. The processor 21 may include one or more processing portions dedicated to specific processing as described below, or the processing may be run in a single processor. Portions for executing such specific processing may also be provided as discrete elements or within one or more further processors or processing portions, such as in one physical processor like a CPU or in several physical entities, for example. Reference sign 22 denotes transceiver or input/output (I/O) units connected to the processor 21. The I/O units 22 may be used for communicating with a communication element such as UE 10. The I/O units 22 may be a combined unit comprising communication equipment towards several network elements, or may include a distributed structure with a plurality of different interfaces for different network elements. Reference sign 23 denotes a memory usable, for example, for storing data and programs to be executed by the processor 21 and/or as a working storage of the processor 21.

The processor 21 is configured to execute processing related to the above described mechanism for controlling the communication mode setting. In particular, the processor 21 includes a sub-portion 211 as a processing portion which is usable for providing a communication mode preference indication allowance to the UE. The portion 211 may be configured to perform processing according to step S100 of FIG. 2, for example. Furthermore, the processor 21 includes a sub-portion 212 usable as a portion for providing an indication related to a (default) prohibit timer. The portion 212 may be configured to perform processing according to step S110 of FIG. 2, for example. In addition, the processor 21 includes a sub-portion 213 as a processing portion which is usable for receiving a communication mode preference indication, and a sub-portion 214 as a processing portion which is usable for processing the received communication mode preference indication. The portions 213 and 214 may be configured to perform processing according to step S120 of FIG. 2, for example. Furthermore, the processor 21 includes a sub-portion 215 as a processing portion which is usable for deciding and effecting a response to the communication mode preference indication. The portion 215 may be configured to perform processing according to step S130 of FIG. 2, for example.

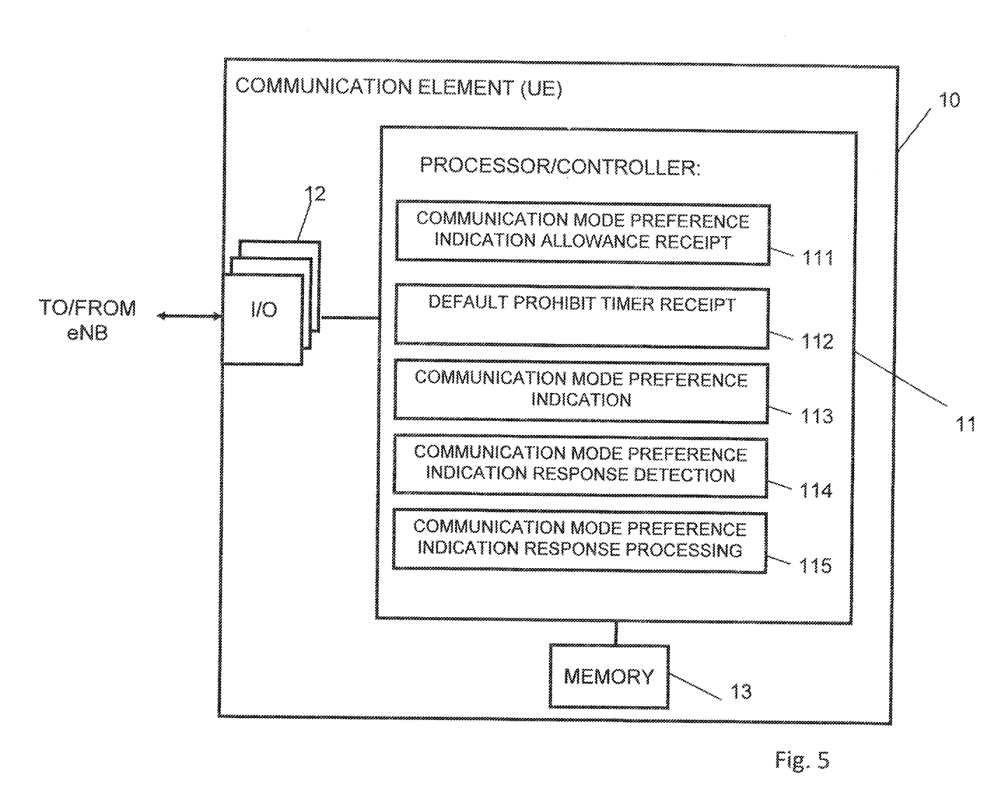

In FIG. 5, a block circuit diagram illustrating a circuitry indicating a configuration of a communication element, such as the UE 10, is shown which is configured to implement the processing for the control mechanism of the communication mode setting as described in connection with embodiments. That is, a circuitry is shown which includes a processing system and/or at least one processor and at least one memory including computer program code the at least one memory and the computer program code being configured to, with the at least one processor, cause the UE 10 to perform functions described herein, for example by executing a corresponding algorithm. It is to be noted that the communication element or UE 10 shown in FIG. 5 may include several further elements or functions besides those described herein, which are omitted for the sake of simplicity as they are not essential for understanding embodiments. Furthermore, even though reference is made to an UE, the communication element may also comprise another terminal device having a similar function, such as a modem chipset, a chip, a module etc., which can also be part of an UE or attached as a separate element to a UE, or the like.

The communication element or UE 10 may include a processing system or processing function or processor 11, such as a CPU or the like, which executes instructions given by programs or the like related to the control mechanism. The processor 11 may include one or more processing portions dedicated to specific processing as described below, or the processing may be run in a single processor. Portions for executing such specific processing may be also provided as discrete elements or within one or more further processors or processing portions, such as in one physical processor such as a CPU or in several physical entities, for example. Reference sign 12 denotes transceiver or input/output (I/O) units connected to the processor 11. The I/O units 12 may be used for communicating with a communication network control element like the eNB 20. The I/O units 12 may be a combined unit comprising communication equipment towards several network elements, or may include a distributed structure with a plurality of different interfaces for different network elements. Reference sign 13 denotes a memory usable, for example, for storing data and programs to be executed by the processor 11 and/or as a working storage of the processor 11.

The processor 11 is configured to execute processing related to the above described mechanism for controlling the power saving procedure. In particular, the processor 11 includes a sub-portion 111 as a processing portion which is usable for receiving an allowance for transmission of the communication mode preference indication. The portion 111 may be configured to perform processing according to step S200 of FIG. 3, for example. Furthermore, the processor 11 includes a sub-portion 112 usable as a portion for receiving information regarding a (default) prohibit timer. The portion 112 may be configured to perform processing according to step S210 of FIG. 3, for example. In addition, the processor 11 includes a sub-portion 113 as a processing portion which is usable for deciding on the requirement to send a communication mode preference indication and to cause the transmission thereof. The portion 113 may be configured to perform processing according to steps S220 and S230 of FIG. 3, for example. Moreover, the processor 11 includes a sub-portion 114 as a processing portion which is usable for detecting whether a response to the communication mode preference indication is received from the eNB 20. The portion 114 may be configured to perform processing according to step S240 of FIG. 3, for example. In addition, the processor 11 includes a sub-portion 115 as a processing portion which is usable for processing a detected response to the communication mode preference indication. The portion 115 may be configured to perform processing according to step S250 of FIG. 3, for example.

According to embodiments, there is provided, for example, an apparatus comprising communication mode preference indication receiving means for receiving a communication mode preference indication, and processing means for processing the received communication mode preference indication, wherein the processing means function is further arranged, as a result of the processing, to cause sending of an explicit response to the communication element transmitting the communication mode preference indication, the response comprising an indicator indicating a response to the communication mode preference indication, or to cause sending of an implicit response to the communication element transmitting the communication mode preference indication by using a signaling with an indication for changing the behavior for transmitting the communication mode preference indication.

According to embodiments, there is provided an apparatus comprising communication mode preference determination means for determining that a specific communication mode preference exists in a communication element, communication mode preference indication means for causing transmission of the communication mode preference indication on the basis of a default prohibit timer defining a time period where a transmission of the communication mode preference indication is allowed or prohibited, communication mode preference indication response detection means for detecting whether a response to the communication mode preference indication is received, and processing means for conducting a processing on the basis of the detection result for a response by the communication mode preference indication response detection means, wherein the processing means is further arranged, in case a response to the communication mode preference indication is detected by the communication mode preference indication response detection means, to process the response for determining whether a behavior for transmitting the communication mode preference indication is to be changed, wherein in case the processing results in that the behavior for transmitting the communication mode preference indication is to be changed, the processing means is further arranged to set a new prohibit timer value for modifying the default prohibit timer value.

For the purpose of the present disclosure as described herein above, it should be noted that
an access technology via which signaling is transferred to and from a network element may be any technology by means of which a network element or sensor node can access another network element or node (e.g. via a base station or generally an access node). Any present or future technology, such as WLAN (Wireless Local Access Network), WiMAX (Worldwide Interoperability for Microwave Access), LTE, LTE-A, Bluetooth, Infrared, and the like may be used; although the above technologies are mostly wireless access technologies, e.g. in different radio spectra, access technology in the sense of the present disclosure implies also wired technologies, e.g. IP based access technologies like cable networks or fixed lines but also circuit switched access technologies; access technologies may be distinguishable in at least two categories or access domains such as packet switched and circuit switched, but the existence of more than two access domains does not impede embodiments being applied thereto,
usable communication networks and transmission nodes may be or include any device, apparatus, unit or means by which a station, entity or other user equipment may connect to and/or utilize services offered by the access network; such services include, among others, data and/or (audio-) visual communication, data download etc.;
a user equipment or communication network element may be any device, apparatus, unit or means which is usable as a user communication device and by which a system user or subscriber may experience services from an access network, such as a mobile phone, a wireless mobile terminal, a personal digital assistant PDA, a smart phone, a personal computer (PC), a laptop computer, a desktop computer or a device having a corresponding functionality, such as a modem chipset, a chip, a module etc., which can also be part of a UE or attached as a separate element to a UE, or the like, wherein corresponding devices or terminals may be, for example, an LTE, an LTE-A, a TETRA (Terrestrial Trunked Radio), a UMTS, a GSM/EDGE etc. smart mobile terminal or the like;
method steps likely to be implemented as software code portions and being run using a processing system and/or processor at a network element or terminal (as examples of devices, apparatuses and/or modules thereof, or as examples of entities including apparatuses and/or modules for it), are software code independent and can be specified using any known or future developed programming language as long as the functionality defined by the method steps is preserved;
generally, any method step is suitable to be implemented as software or by hardware without changing the ideas of embodiments in terms of the functionality implemented;
method steps and/or devices, apparatuses, units or means likely to be implemented as hardware components at a terminal or network element, or any module(s) thereof, are hardware independent and can be implemented using any known or future developed hardware technology or any hybrids thereof, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, apparatuses, units or means can be implemented as individual devices, apparatuses, units or means, but this does not exclude that they are implemented in a distributed fashion throughout the system, as long as the functionality of the device, apparatus, unit or means is preserved; for example, for executing operations and functions according to embodiments, one or more processors may be used or shared in the processing, or one or more processing sections or processing portions may be used and shared in the processing, wherein one physical processor or more than one physical processor may be used for implementing one or more processing portions dedicated to specific processing as described,
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independent of each other but in a same device housing, for example.

Furthermore, as used in this application, the terms ‘device’ or ‘circuitry’ refer to all of the following: (a) hardware-only circuit implementations (such as implementations in only analog and/or digital circuitry) and (b) combinations of circuits and software (and/or firmware), such as (as applicable): (i) a combination of processor(s) or (ii) portions of processor(s)/software (including digital signal processor(s)), software, and memory(or memories) working together to cause an apparatus, such as a mobile phone or server, to perform various functions) and (c) circuits, such as a microprocessor (or plural microprocessors) or a portion of a microprocessor (or plural microprocessors), that requires/require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device

As described above, there is provided a mechanism for controlling a communication mode setting, such as a power saving procedure in a UE. A UE sends a communication mode preference indication to a communication network control element under consideration of a default prohibit timer. When a response to the communication mode preference indication is received by the UE, it determines whether a change of the behavior for transmitting the power preference information, i.e. a change of a prohibit timer value, is to be executed.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of embodiments, which is defined in the accompanying claims.

What is claimed:

1. Apparatus for use in controlling a communication mode setting, the apparatus comprising at least one processor and at least one memory including computer program code, the at least one memory and the computer program code being configured to, with the at least one processor, cause the apparatus at least to perform:
a communication mode preference indication receiving function arranged to receive a communication mode preference indication; and
a processing function arranged to process the received communication mode preference indication, wherein the processing function is further arranged, as a result of the processing:
to cause sending of an explicit response to the communication element transmitting the communication mode preference indication, the response comprising an indicator indicating a response to the communication mode preference indication, or
to cause sending of an implicit response to the communication element transmitting the communication mode preference indication by using a signaling with an indication for changing the behavior for transmitting the communication mode preference indication.

2. Apparatus according to claim 1, wherein the at least one memory and the computer program code are configured to, with the at least one processor, cause the apparatus to perform a communication mode preference indication allowing function arranged to cause transmission of an indication for allowing a transmission of a communication mode preference indication by the communication element for requesting a communication mode for the communication element,
wherein the communication mode preference indication allowing function is arranged to cause transmission of the indication for allowing the transmission of the communication mode preference indication by at least one of a dedicated signaling to at least one communication element and a broadcast signaling.

3. Apparatus according to claim 1, wherein the at least one memory and the computer program code are configured to, with the at least one processor, cause the apparatus to perform a default prohibit timer informing function arranged to cause transmission of information concerning a default prohibit timer defining a time period where a transmission of a communication mode preference indication is prohibited for a communication element,
wherein the default prohibit timer informing function is arranged to cause transmission of the information concerning the default prohibit timer by at least one of a dedicated signaling to at least one communication element and a broadcast signaling.

4. Apparatus according to claim 2, wherein, in the case of a dedicated signaling to the at least one communication element being used, the communication mode preference indication allowing function is arranged to introduce the indication for allowing the transmission of the communication mode preference indication in a radio resource control signaling to the at least one communication element, the indication comprising at least one of:
a bitmap indicating whether the communication mode preference indication is receivable and processable,
an information element indicating the allowance of transmission of the communication mode preference indication, and
a response to an indication received from the at least one communication element that a function for sending a communication mode preference indication is supported.

5. Apparatus according to claim 2, wherein, in the case of a broadcast signaling being used, the communication mode preference indication allowing function is arranged to introduce the indication for allowing the transmission of the communication mode preference indication in a system information signaling comprising at least one of:
a system information block including an indicator that the communication mode preference indication is allowed,
a system information block including an indicator that the communication mode preference indication is allowed and an information element dividing communication elements into classes of communication elements being allowed to send the communication mode preference indication and classes of communication elements not being allowed to send the communication mode preference indication, and
a group paging signaling indicating a specified time period for which the transmission of the communication mode preference indication is allowed.

6. Apparatus according to claim 3, wherein the default prohibit timer informing function arranged to cause transmission of the information concerning the default prohibit timer defining the time period where the transmission of the communication mode preference indication is prohibited for the communication element is further arranged to provide, as the information, a parameter including at least one of:
a trigger element for triggering an internal timer used as the default prohibit timer,
an explicit time period indication,
an indication to use a paging cycle for spreading time instants for transmitting the communication mode preference indication,
an indication of a start offset indicating to transmit the communication mode preference indication once per hyperframe, and
an indication keyed to a subframe number.

7. Apparatus according to claim 1, wherein the processing function arranged to process the received communication mode preference indication is further arranged, as a result of the processing, to:
inhibit a transmission of a response to the communication mode preference indication, or
when causing sending of the explicit response to the communication element to use a radio resource control configuration signaling comprising the indicator indicating a response to the communication mode preference indication, or
when causing sending of the implicit response to the communication element to use a radio resource control configuration signaling with a discontinuous reception configuration parameter.

8. Apparatus according to claim 7, wherein the processing function is further arranged, when as a result of the processing sending of an implicit response to the communication element transmitting the communication mode preference indication is caused, to use a discontinuous reception configuration parameter indicating one of:
a discontinuous reception cycle different from a previous discontinuous reception cycle,
a discontinuous reception cycle different from a predetermined value, and
an on-duration of the communication element in a discontinuous reception cycle.

9. Apparatus according to claim 1, wherein the communication mode preference indication is one of:
an indication of a lower power consumption preference,
an indication of an improved communication performance preference, and
an indication for a fast dormancy request.

10. Apparatus according to claim 1, wherein the apparatus is comprised in a communication network control element of a cellular communication network, in particular a base station or a radio network controller of a universal mobile telecommunication system communication network, or an evolved node B of a Long Term Evolution or Long Term Evolution Advanced communication network, and wherein the communication element is a terminal device or user equipment connectable to the communication network control element.

11. Apparatus for use in controlling a communication mode setting, the apparatus comprising at least one processor and at least one memory including computer program code, the at least one memory and the computer program code being configured to, with the at least one processor, cause the apparatus at least to perform:
a communication mode preference determination function arranged to determine that a specific communication mode preference exists in a communication element;
a communication mode preference indication function arranged to cause transmission of the communication mode preference indication on the basis of a default prohibit timer defining a time period where a transmission of the communication mode preference indication is allowed or prohibited;
a communication mode preference indication response detection function arranged to detect whether a response to the communication mode preference indication is received; and
a processing function arranged to conduct a processing on the basis of the detection result for a response by the communication mode preference indication response detection function, wherein the processing function is further arranged:
in the case of a response to the communication mode preference indication being detected by the communication mode preference indication response detection function, to process the response for determining whether a behavior for transmitting the communication mode preference indication is to be changed,
wherein in the case of the processing resulting in the behavior for transmitting the communication mode preference indication being changed, the processing function is further arranged to set a new prohibit timer value for modifying the default prohibit timer value.

12. Apparatus according to claim 11, wherein at least one processor and at least one memory including computer program code, the at least one memory and the computer program code being configured to, with the at least one processor, cause the apparatus at least to perform a communication mode preference indication allowance receiving function arranged to receive an allowance to transmit a communication mode preference indication for requesting a communication mode for the communication element,
wherein the communication mode preference indication allowance receiving function is arranged to receive the allowance for the communication mode preference indication transmission by at least one of a dedicated signaling to the communication element and a broadcast signaling.

13. Apparatus according to claim 11, wherein at least one processor and at least one memory including computer program code, the at least one memory and the computer program code being configured to, with the at least one processor, cause the apparatus at least to perform a default prohibit timer information receiving function arranged to receive information concerning the default prohibit timer,
wherein the default prohibit timer information receiving function is arranged to receive the information concerning the default prohibit timer by at least one of a dedicated signaling to the communication element and a broadcast signaling.

14. Apparatus according to claim 12, wherein, in the case of a dedicated signaling to the communication element being received, the communication mode preference indication allowance receiving function is arranged to determine the allowance for the transmission of the communication mode preference indication from a radio resource control signaling to the communication element, the indication comprising at least one of:
a bitmap indicating whether the communication mode preference indication is receivable and processable,
an information element indicating the allowance of transmission of the communication mode preference indication, and
a response to an indication sent by the communication element that a function for sending a communication mode preference indication is supported.

15. Apparatus according to claim 12, wherein, in the case of a broadcast signaling being received, the communication mode preference indication allowance receiving function is arranged to determine the allowance for the transmission of the communication mode preference indication from a system information signaling comprising at least one of:
a system information block including an indicator that the communication mode preference indication is allowed,
a system information block including an indicator that the communication mode preference indication is allowed and an information element indicating that the communication element is assigned to a class of communication elements being allowed to send the communication mode preference indication or to a class of communication elements not being allowed to send the communication mode preference indication, and
a group paging signaling indicating a specified time period for which the transmission of the communication mode preference indication is allowed.

16. Apparatus according to claim 13, wherein the default prohibit timer information receiving function is arranged to receive, as the information concerning the default prohibit timer, a parameter including at least one of:
a trigger element for triggering an internal timer used as the default prohibit timer,
an explicit time period indication,
an indication to use a paging cycle for spreading time instants for transmitting the communication mode preference indication,
an indication of a start offset indicating to transmit the communication mode preference indication once per hyperframe, and
an indication keyed to a subframe number.

17. Apparatus according to claim 11, wherein the communication mode preference indication response detection function is further arranged to detect that a response to the communication mode preference indication is received by detecting at least one of:
an explicit response by using a radio resource control configuration signaling comprising an indicator indicating a response to the communication mode preference indication, or
an implicit response by using a radio resource control configuration signaling with an indication that the behavior for transmitting the communication mode preference indication is to be changed.

18. Apparatus according to claim 17, wherein the communication mode preference indication response detection function is arranged, when an implicit response is received, to determine, as the indication that the behavior for transmitting the communication mode preference indication is to be changed, a discontinuous reception configuration parameter indicating one of:
a discontinuous reception cycle different from a previous discontinuous reception cycle,
a discontinuous reception cycle different from a predetermined value, and
an on-duration of the communication element in a discontinuous reception cycle.

19. Apparatus according to claim 11, wherein the processing function arranged to conduct a processing on the basis of the detection result of the communication mode preference indication response detection function is further arranged:
in the case of no response to the communication mode preference indication being detected by the communication mode preference indication response detection function, to cause the communication mode preference indication function to cause transmission of the communication mode preference indication on the basis of the default prohibit timer when the specific communication mode preference still exists, and
in the case of a response to the communication mode preference indication being detected by the communication mode preference indication response detection function,
in the case of the processing resulting in the behavior for transmitting the communication mode preference indication being changed, the processing function is further arranged to maintain the default prohibit timer value.

20. Apparatus according to claim 11, wherein the processing function is further arranged, in the case of the processing resulting in the behavior for transmitting the power preference indication being changed, to calculate the new prohibit timer value by multiplying the default prohibit timer by a specified scaling factor.

21. Apparatus according to claim 11, wherein the communication mode preference indication is one of:
an indication of a lower power consumption preference,
an indication of an improved communication performance preference, and
an indication for a fast dormancy request.

22. Apparatus according to claim 11, wherein the apparatus is comprised in a communication element comprising a terminal device or user equipment connectable to a communication network control element of a cellular communication network, in particular a base station or radio network controller of a universal mobile telecommunication system, or an evolved node B of a Long Term Evolution or Long Term Evolution Advanced communication network.

23. A method for use in controlling a communication mode setting, the method comprising:
receiving a communication mode preference indication; and
processing the received communication mode preference indication, and, as a result of the processing:
causing sending of an explicit response to the communication element transmitting the communication mode preference indication, the response comprising an indicator indicating a response to the communication mode preference indication, or
causing sending of an implicit response to the communication element transmitting the communication mode preference indication by using a signaling with an indication for changing the behavior for transmitting the communication mode preference indication.

24. A method for use in controlling a communication mode setting, the method comprising:
determining that a specific communication mode preference exists in a communication element;
causing transmission of the communication mode preference indication on the basis of a default prohibit timer defining a time period where a transmission of the communication mode preference indication is allowed or prohibited;
detecting whether a response to the communication mode preference indication is received, and
conducting a processing on the basis of the detection result for a response, wherein the processing comprises:
in the case of a response to the communication mode preference indication being detected, processing the response for determining whether a behavior for transmitting the communication mode preference indication is to be changed,
wherein in the case of the processing resulting in the behavior for transmitting the communication mode preference indication being changed, setting a new prohibit timer value for modifying the default prohibit timer value.
